(19) United States
(12) Patent Application Publication
(10) Pub. No.: US 2013/0292880 A1
(43) Pub. Date: Nov. 7, 2013

(54) CERAMIC FILES AND BURS

(71) Applicant: Jean-Marc Boechat, Marly (CH)

(72) Inventor: Jean-Marc Boechat, Marly (CH)

(73) Assignee: ECOLE D'INGENIEURS ET D'ARCHITECTES DE FRIBOURG, Fribourg (CH)

(21) Appl. No.: 13/821,104

(22) PCT Filed: Sep. 6, 2011
(86) PCT No.: PCT/IB11/53895

§ 371 Date: May 24, 2013

(30) Foreign Application Priority Data
Sep. 7, 2010 (EP) 10175675.7

(51) Int. Cl. B24D 18/00; B23D 71/00; B23D 73/00; B24D 3/14

(52) U.S. Cl. CPC B24D 18/0009; B24D 3/14; B23D 71/00; B23D 73/00
USPC 264/328.14; 451/540; 407/29.1

(57) ABSTRACT

The present invention concerns a cutting or abrasive tool (1) such as a bur or a file that is produced by ceramic injection moulding with specific profiles or teeth. The tool can be a bur or a file that is directly produced by this process with no need for an extra treatment. Such tools are easily and cheaply produced and can be single use tools. The defect line (2) at the mould split plane location may advantageously be used as part of the abrasive or cutting profile. The tool may be made from stabilised zirconium dioxide (ZrO2), pure aluminium oxide (Al2O3) or a mixture of both. The cutting profile may include a face angle of about 5 degrees, a back angle of about 17 degrees and a gullet angle of 78 degrees (see FIG. 2).

### FIELD OF THE INVENTION

This invention relates to the production of ceramic objects with cutting edge or abrasive properties.

More particularly, the present invention is directed to a method to form net-shape objects without the need for machining operations.

Examples of application of the invention are the production of cutting tools like saws, files, burs, in particular for the medical, surgery or food processing fields.

### BACKGROUND OF THE INVENTION

Today's state of the art for cutting tools like saws, files, burs, etc. is to use either tool steel or stainless steels. The tool steels provide very good cutting properties due to their high hardness after heat treatment.

The stainless steels are normally pretty corrosion resistant during use and sterilization processes. The problem is that it is almost impossible to get steels that are at the same time hard and corrosion resistant. Moreover these materials are difficult to clean after use and may have to be sterilized by means that are more efficient than the normal autoclave, thus inducing higher costs.

Ceramics on another hand do not show these difficulties because they are naturally hard and corrosion-free as well as mechanically resistant at least for some types. Their hardness does not depend on heat treatments like steel.

In other words they will not lose their mechanical properties even if they are heat treated at relatively high temperature during their life.

The prior art contains the following publications, which are incorporated by reference in their entirety in the present application.

Document DE 42 02 953 discloses a saw blade that is made of ceramics.

Documents DE 20314 717 U1 and DE 10 2006 049581 disclose a drill that is made of a first shaft and a working part, said working part being made of ceramics.

Document US 2008/0064303 discloses a ceramic surgical instrument made by grinding.

Document EP 1 849 429 concerns dental drill made of ceramics that are machined.

Document DE 10 2005 059 864 discloses a method for producing ceramic tools which are sintered and then undergo a HIP (Hot isostatic pressing) treatment in presence of oxygen at a temperature just under the sintering temperature.

Other prior art publications include EP 0 447 726, U.S. Pat. No. 5,515,231, US 2002/128582.

### BRIEF DESCRIPTION OF THE INVENTION

An aim of the present invention is to improve the known methods and products.

Another aim of the present invention is to provide a simple method to produce tools, such as files or burs or other tools, in a simple and efficient manner.

According to the present invention, an idea is to use a production process step of ceramic injection molding.

A basic idea of the present is to make good use of the natural hardness of ceramics and the advantages of injection molding to manufacture cutting tools for work requiring a maximal cleanliness like surgery or food processing. Most of the ceramics are biocompatible materials which facilitates their use in these applications.

In an embodiment, the invention relates to a method for making cutting tools, such as burs or files, wherein the process comprises the following steps:
provision of a mold with a predetermined abrasive or cutting profile for said tool;
injection of ceramic into said mold using a ceramic injection molding process (CIM) and
sintering of said injected ceramic to produce said tool without posterior treatment.

In an embodiment, the profile is adapted to the intended use of the tool and to CIM.

In an embodiment, the profile comprises a rasp profile or a cutting profile.

In an embodiment, the ceramic is stabilized zirconium oxide particularly ZrO₂ with 5% Y₂ O₃, or Pure Aluminum Oxyde or a mix thereof.

In an embodiment, the invention relates to a cutting tool such as bur or a file, wherein said tool is made by a method according to the present invention.

In an embodiment, the tool comprises a predetermined abrasive or cutting profile.

In an embodiment the profile of the tool is adapted to the intended use and to the production method of said tool.

In an embodiment, the profile is formed at least by a split plane defect.

In an embodiment, the profile comprises a rasp profile or a cutting profile wherein the back angle (α) has a value of about 17°, the gullet angle (β) a value of about 78° and the face angle (γ) a value of about 5°.

In an embodiment, the tool is made of stabilized zirconium oxide particularly ZrO₂ with 5% Y₂ O₃, or Pure Aluminum Oxyde or a mix thereof.

### DETAILED DESCRIPTION OF THE INVENTION

The present invention will be better understood by the description of different embodiments and the following drawings which show

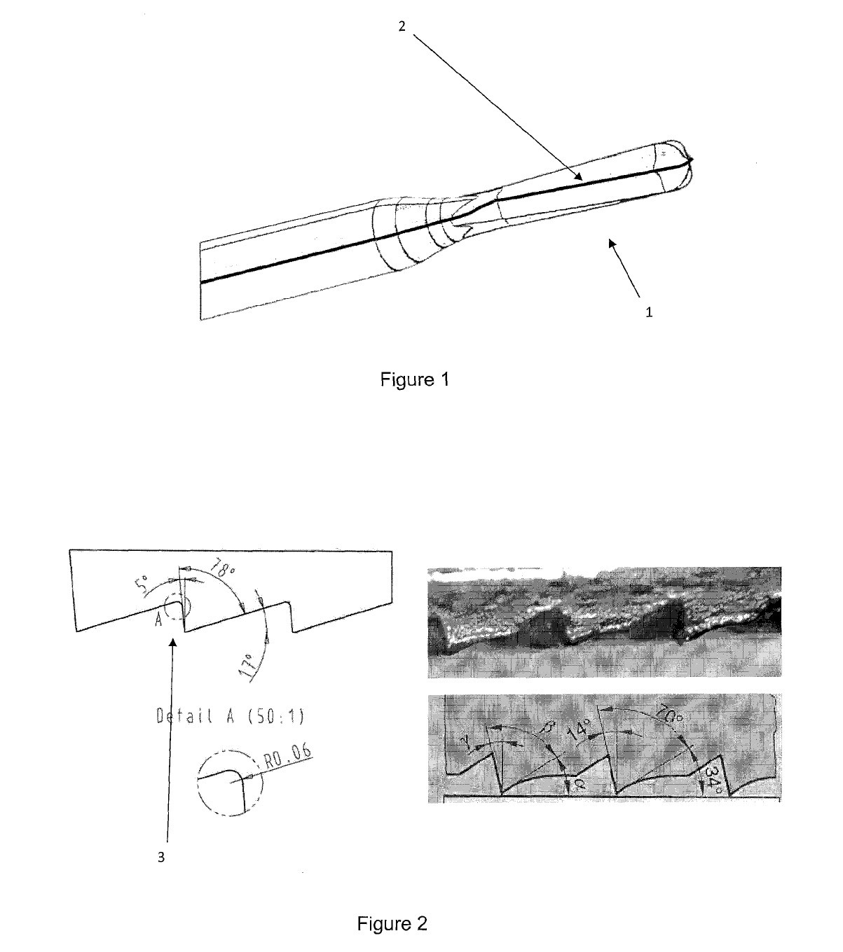

FIG. 1 illustrates a dental bur design with split plane location;

FIG. 2 illustrates a file tooth ceramic design detail compared with a typical steel precision file.

The present invention can be split in two separate chapters or applications: one for medical burs and the other for files. The two share the same basic manufacturing technology: CIM (Ceramic Injection Molding). This process enables to produce very complex shapes with very high productivity hence high end cutting tools at a fairly low price. Therefore the technology described here open the way to single use of surgery or dentistry tools, solving the cleaning or contamination problem definitely in accordance with the principles indicated above.

FIG. 1 illustrates an example of a dental bur 1 design with split plane 2 location.

For the dental burs, shown as a non limiting example in FIG. 1, the so called split plane 2 defect is used as an advantage to improve the cutting properties of the bur.

All injected parts show a normally tiny defect line at the mold split plane location. This line is usually considered as a defect because it is unavoidable but not part of the original shape design. There is thus usually a need to remove said defect by an additional treatment step.

The present invention uses it as an advantageous feature to receive—out of the mold—burs with a cutting edge without an additional sharpening or subsequent machining steps. This net shape process allows us to produce burs with a sharp cutting edge at a very low cost hence usable as single use tools.

The method of the invention thus allows a simple and efficient production of tools with no posterior treatment as in the prior art.

FIG. 2 illustrates a file tooth ceramic design detail compared with a typical steel precision file.

The cutting profile 3 illustrated in FIG. 2 of the files manufactured by injection molding has been redesigned taking into account the specific mechanical properties of the used ceramic material and the angles illustrated γ as face angle, β as gullet angle and α as back angle. The geometry and stresses have been evaluated by finite element method and the particular shape on the file tooth adapted so that the mechanical stresses encountered during the filing process can be sustained without damage of the file. In the present case, this means for the back angle α a value of about 17°, for the gullet angle β a value of about 78° and for the face angle y a value of about 5°.

Of course, other values may be used depending on the circumstances.

This step is of paramount importance for the steel tooth design, if taken one to one in ceramic, will not provide the required resistance and the file would wear out very fast. An advantage provided by the injection method is that it guarantees a true replication of any profile designed hence enabling an adaption of each file to its intended use, with for example specific profiles for specific uses.

It is therefore possible to produce genuine precision files with reproducible geometry and mechanical characteristics with this technology. Such tools are easily and cheaply produced and can be single use tools.

Although these ceramic tools are mostly intended for medical work or food processing, other applications can benefit from such tools like the oil drilling industry and all explosion proof work area for these tools do not produce sparks like the steel files.

As they are sintered at very high temperature they come out of the process clean and sterile so there is in principle no need for additional treatment steps such as for example sterilization.

Another benefit is that these tools can be cleaned by high temperature heating like torching without loss of properties unlike their steel counterparts. Therefore, very simple means can be used to obtain an acceptable result.

Typical materials that can be used in the present invention are the following: Doped Zirconium Oxyde, Aluminum Oxyde or a mix thereof. Preferably, the materials used include stabilized zirconium oxide particularly ZrO₂ with 5% Y₂ O₃, or Pure Aluminum Oxyde (>99.5% pure) or a mix thereof

Of course, all the embodiments described above are given as examples and should not be construed in a limiting manner. Equivalent means are possible as also other tools that have comparable properties and given embodiments may be combined together according to circumstances.

1. A method for making cutting tools, such as burs or files, wherein the process comprises the following steps:
provision of a mold with a predetermined abrasive or cutting profile for said tool;
injection of ceramic into said mold using a ceramic injection molding process (CIM) and
sintering of said injected ceramic to produce said tool without posterior treatment.

2. The method of claim 1, wherein said profile is adapted to the intended use of the tool and to CIM.

3. The method as defined in claim 2, wherein said profile comprises a rasp profile or a cutting profile.

4. The method as defined in claim 1, wherein said ceramic is stabilized zirconium oxide particularly ZrO₂ with 5% Y₂ O₃, or Pure Aluminum Oxyde or a mix thereof

5. A cutting tool such as bur or a file, wherein said tool is made by a method as defined in claim 1.

6. The tool as defined in claim 5, wherein it comprises a predetermined abrasive or cutting profile.

7. The tool as defined in claim 6, wherein the profile is adapted to the intended use and to the production method of said tool.

8. The tool as defined in, wherein said profile is formed at least by a split plane defect.

9. The tool as defined in claim 5, wherein the profile comprises a rasp profile or a cutting profile wherein the back angle (α) has a value of about 17°, the gullet angle (β) a value of about 78° and the face angle (γ) a value of about 5°.

10. The tool as defined in claim 5, wherein it is made of stabilized zirconium oxide particularly ZrO₂ with 5% Y₂ O₃, or Pure Aluminum Oxyde or a mix thereof.
